(19) United States
(12) Patent Application Publication
(10) Pub. No.: US 2009/0241417 A1
(43) Pub. Date: Oct. 1, 2009

(54) Open Bottomed Planting Pot with Releaseable Bottom Cover

(76) Inventor: Thomas J. Smith, Carleton, MI (US)

Correspondence Address: MCCARTER & ENGLISH, LLP NEWARK, FOUR GATEWAY CENTER, 100 MULBERRY STREET, NEWARK, NJ, 07102, US

(21) Appl. No.: 12/058,701

(22) Filed: Mar. 29, 2008

(51) Int. Cl. A01G 9/02

(52) U.S. Cl. 47/66.2; 47/65.5; 47/66.7

(57) ABSTRACT

Disclosed herein are systems and method for facilitating root growth and convenient planting. In an exemplary embodiment of the present invention, the system is provided with a plant pot and a cover, such as a tray, a shrink-wrap, a base, etc. The plant pot has a plant chamber for containing soil, a plant, etc. The plant pot has a pot bottom portion with at least one opening, and can be completely open, such that the bottom portion of the plant pot is at least substantially open to allow root growth from the plant chamber, through the at least one opening and into surrounding soil. The system can be provided with a tray, for example, that securingly receives the plant pot. As other examples, the system can be provided with plastic for wrapping the bottom portion and/or a cover for forming a friction fit with the plant pot.

### FIELD OF THE INVENTION

The present invention relates generally to a plant pot and bottom cover therefor. More particularly, exemplary embodiments of the present invention relate to an open bottomed plant pot and cover system and methods that facilitate root growth and convenient planting.

### BACKGROUND OF THE INVENTION

Plant pots are well known in the art for holding plants until the plant is planted in a planter or in the ground. Though such might be a relatively straightforward task for a professional, amateur planters can often cause root damage during the transfer process. In this regard, it is known in the art to provide a basket with perforations for allowing root growth therethrough. It has been difficult, however, to provide a plant pot having enough open space to allow for a substantially unobstructed path for root growth, while, at the same time, providing sufficient structural integrity to the plant pot, such that the roots and soil are maintained in the pot prior to planting. What is needed in the art, is a plant pot and cover system that overcomes these and other disadvantages and shortcomings of the prior art.

### SUMMARY OF THE INVENTION

The present invention overcomes the disadvantages and shortcomings of the prior art by providing a plant pot with a substantially open bottom and a bottom cover for at least temporarily enclosing the bottom.

In accordance with an exemplary embodiment of the present invention, the plant pot includes a body and a pot bottom portion extending from the body to define a plant chamber for containing a plant and soil. The bottom portion can include positive and negative space, such as a pot bottom wall and openings extending therethrough so that the bottom portion is substantially open, though it is contemplated that the substantially open bottom portion can be fully-open, e.g., substantially all negative space and/or with no pot bottom wall. In this regard, when the plant pot is positioned on or in soil with the bottom portion adjacent thereto, root growth is allowed to occur from the pot soil in the plant chamber, through the negative space, and into soil. The openings can be aligned along concentric radial axes, and the openings can be evenly distributed and/or staggered across the pot bottom portion, so as to both provide balanced structural integrity and enhance the probability that roots will “find” openings proximal thereto to grow through.

It is contemplated that the bottom cover for the plant pot can be provided as shrink-wrap and/or any structure suitable for the purposes herein described. In an exemplary embodiment, the bottom cover is provided as a tray, and the tray is configured to securingly attach to the plant pot so as to substantially cover the bottom portion of the pot. The tray thereby retains any soil and plant within the pot during shipping and display. The tray can have a resiliently flexible sidewall for providing a bias force that secures the plant pot within a receiving area of the tray with a snap-fit, or the tray can be provided with additional or alternative means for securing the tray to the plant pot. Moreover, the plant pot itself can have a body portion that tapers in a direction away from the tray, such that the resiliently flexible portion of the tray can form a snap-fit entrapping the body portion within the receiving area. In use, after a plant within the pot is purchased, it can be planted by removing the tray and placing the remainder of the pot onto—or recessed into—soil at a planting location.

In some aspects of the present invention, the plant pot can be provided with a substantially-open pot bottom portion that is fully-open, e.g., substantially all negative space and/or with no pot bottom wall. In this regard, the bottom cover can be provided as a removable bottom wall of the plant pot. The bottom cover could be a disc-like base with an annular boss extending therefrom, such that the annular boss has an outer diameter that is the same or slightly greater than an inner diameter of the pot bottom portion and forms a friction fit therewith. It is contemplated that the plant pot and bottom cover can be formed of a fibrous material, such as recycled fiber, and in some aspects, the plant pot and bottom cover can be integrally formed and delineated by one or more perforations, such that the integrally-formed plant pot and bottom cover can be separated by a user along the perforations.

Additional features, functions and benefits of the disclosed plant pot and cover system will be apparent from the detailed description which follows, particularly when read in conjunction with the accompanying figures.

### BRIEF DESCRIPTION OF THE DRAWINGS

For a more complete understanding of the present invention, reference is made to the following detailed description of exemplary embodiment(s) considered in conjunction with the accompanying drawings, in which:

FIG. 1 is a perspective assembly view showing a plant pot and cover system, the system being shown to include a plant pot and a tray;

FIG. 2A is a top plan view of the plant pot of FIG. 1, a bottom portion of the plant pot being shown to include radially aligned openings;

FIG. 2B is a broken top plan view of an alternate embodiment of the bottom portion of the tray shown in FIG. 2A;

FIG. 3 is an elevational view of the plant pot of FIG. 1;

FIG. 4 is a top plan view of the tray of FIG. 1;

FIG. 5 is an elevational view of the tray of FIG. 1;

FIG. 6 is a cross-sectional view showing the plant pot being received by the tray, the cross-section having been taken along section line 6-6 of FIG. 1;

FIG. 6A is an enlarged view of a snap-fit formed by the plant pot and the tray of FIGS. 1 and 6;

FIG. 7A is an illustration showing the plant pot of FIG. 1 buried in the soil of the ground with a plant and soil contained within the plant pot, the plant pot having a section thereof broken away to show that roots of the plant have grown from the soil within the pot, through a pot bottom portion of the plant pot, and into the surrounding soil of the ground;

FIG. 7B is an illustration showing the plant pot of FIG. 1 sifting on top of the soil of a decorative planting structure with a plant and soil contained within the plant pot, the plant pot and decorative planting structure having sections thereof broken away to show that roots of the plant have grown from the soil within the pot, through a pot bottom portion of the plant pot, and into the soil of the decorative planting structure;

FIG. 8A is a perspective assembly view showing a system including a plant pot and transparent shrink wrap removably secured thereto;

FIG. 8B is a perspective assembly view showing another system including a plant pot and transparent shrink wrap removably secured thereto;

FIG. 9 is an exploded perspective view showing a system including a plant pot having a fully-open bottom portion and a cover therefor;

FIG. 10 is a cross-sectional view showing the exploded plant pot and cover of FIG. 9 with the cross-section having been taken along section line 10-10 thereof;

FIG. 11 is the cross-section of FIG. 10 with the plant pot and cover of FIGS. 9-10 shown in assembled form;

FIG. 12 is a top plan view of the plant pot and cover of FIGS. 9-11 in assembled form;

FIG. 13 is a bottom plan view of the plant pot and cover of FIGS. 9-12 in assembled form; and

FIG. 14 is a bottom plan view of a plant pot and cover having a unitary structure.

### DETAILED DESCRIPTION OF THE EXEMPLARY EMBODIMENTS

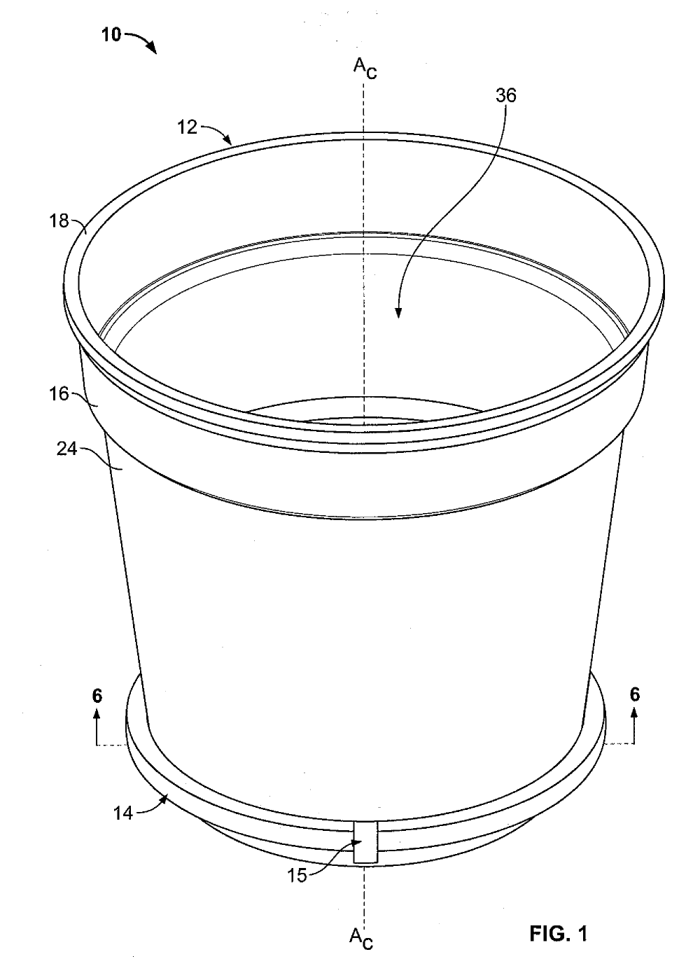

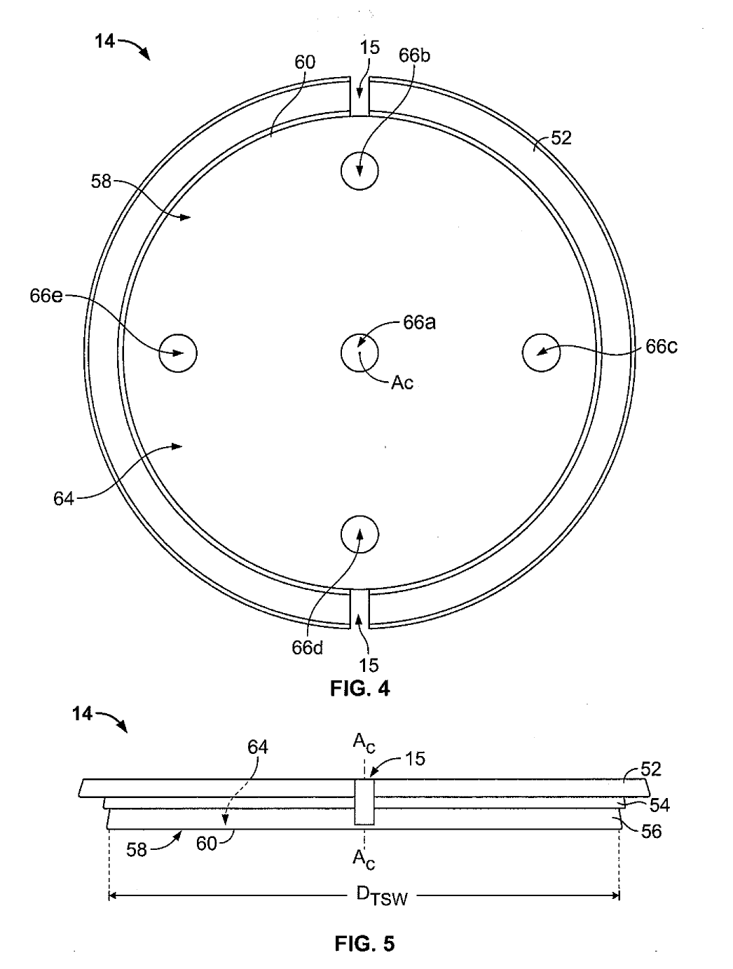

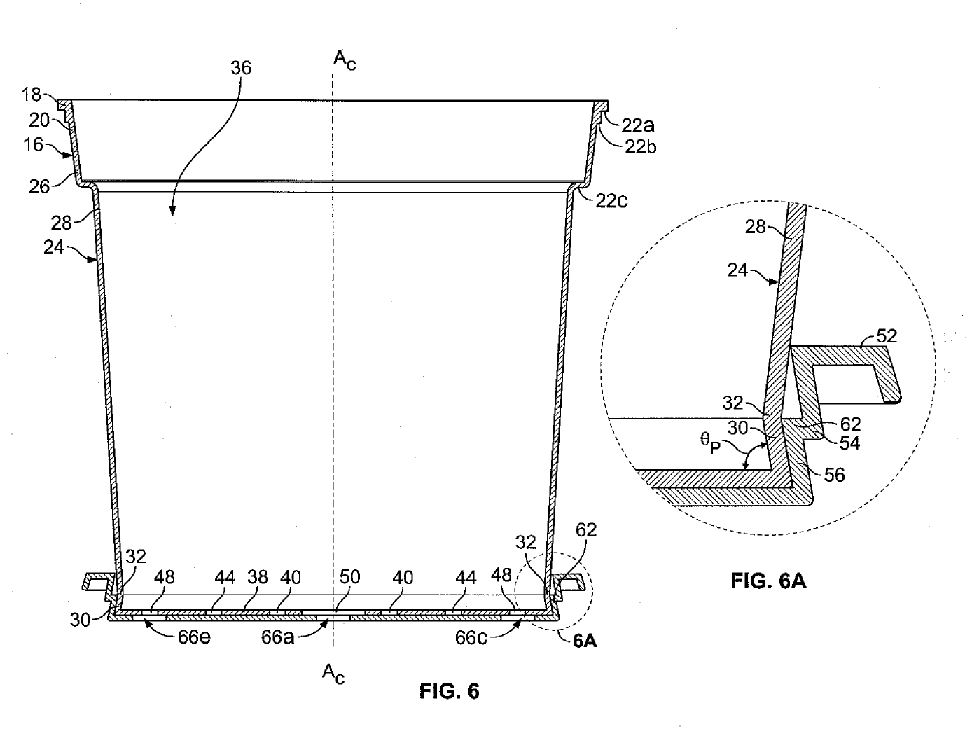

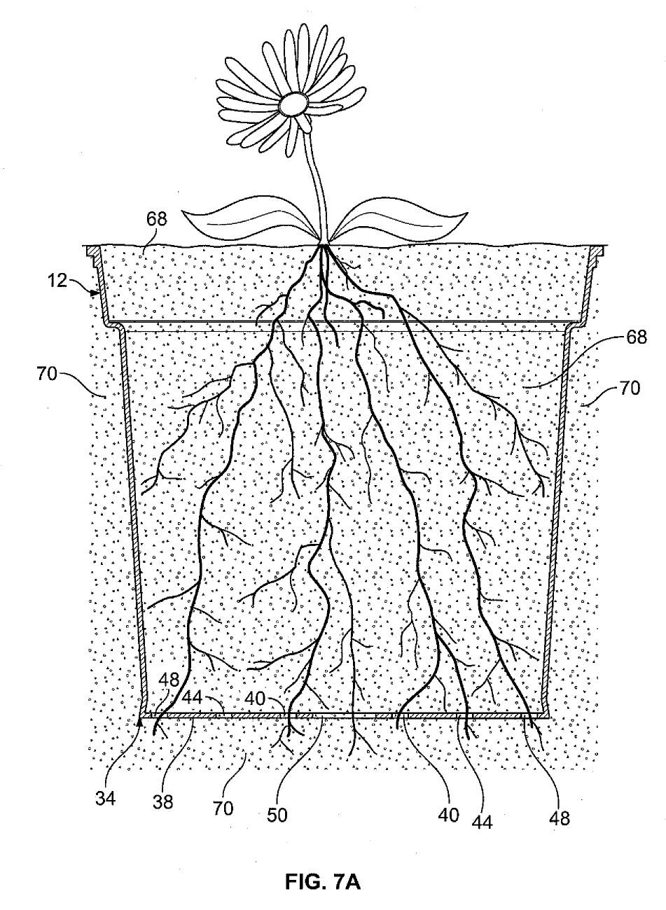

Referring to FIGS. 1-6, a plant pot and cover system 10 is shown constructed in accordance with an exemplary embodiment of the invention. The system 10 includes at least one plant pot 12 and a bottom cover, such as a tray 14, for receiving the at least one plant pot 12. Each of the plant pot 12 and the tray 14 shall be discussed below with further detail.

Needless to say, the plant pot 12 can have any suitable shape and be made of any suitable material. Referring to FIGS. 1-3 and 6, the plant pot 12 includes a top portion 16 that extends annularly about a central axis Ac and further includes a rim 18 that extends radially from a first end 20 of the top portion 16. Such a rim 18 can be tiered and/or include a plurality of bottom surfaces, e.g., rim bottoms 22a, 22b. The top portion 16 can have a second end 26 with a lower surface 22c.

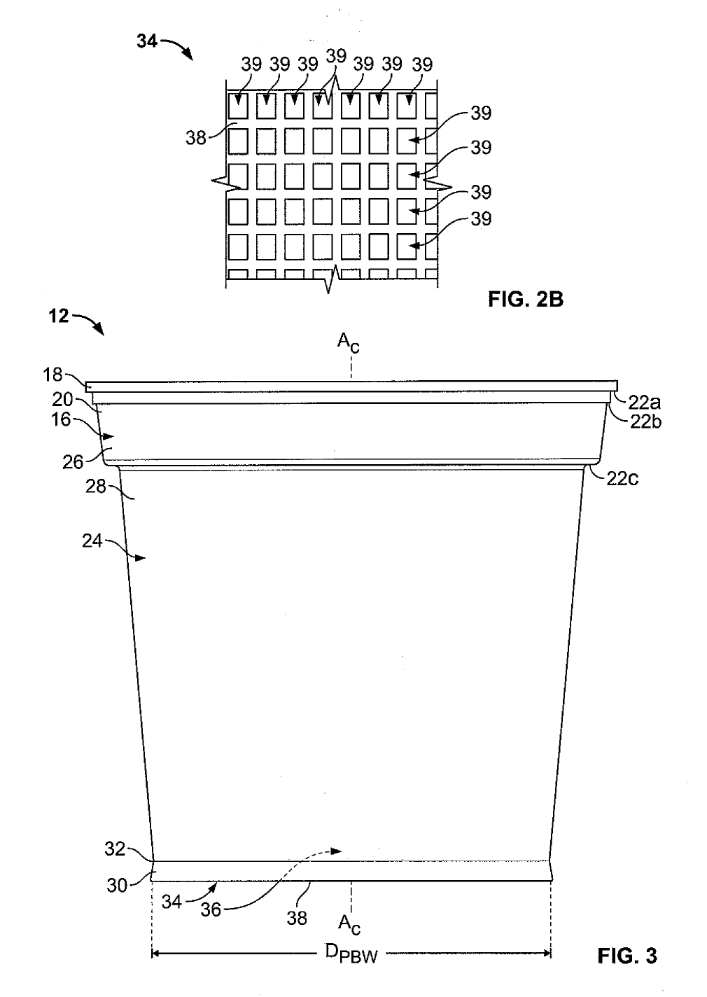

The plant pot 12 can include a body 24 that extends from the top portion 16 to form an annular surface proximal the top portion 16, which extends about the central axis A_{C}. As shown in FIG. 3, the top portion 16 can be downwardly tapered in a direction toward the body 24, such that a cross-section of the top portion 16 proximal the rim 18 has a first radius (not designated) and that a cross-section of the of the top portion 16 proximal the body 24 had a second radius (not designated) less than the first radius.

The body 24 includes a first body portion 28, which includes a first continuous sidewall extending from the top portion 16 so as to be tapered (getting smaller) in a direction away from the top portion 16, and a second body portion 30, which includes a second continuous sidewall extending from the first body portion 28 so as to be flared (getting larger) in a direction away from the first body portion 28. A first annular edge 32 is formed at the juncture of the first body portion 28 and the second body portion 30. So as to provide structural integrity to the plant pot 12, the body 24 may be monolithically formed as is known in the art. The body 24 can be substantially free of any openings defined therethrough.

The plant pot 12 includes a pot bottom portion 34 proximal a lower end of the second body portion 30 opposite the annular edge 32. A chamber, referenced as a plant chamber 36, is defined between the pot bottom portion 34 and the body 24 and the top portion 16 for receiving plants and soil therefore, which is referenced herein as “pot soil” to designate that such is a planting medium, of any type, contained within the pot As further described below, the pot bottom portion 34 can include a pot bottom wall 38 extending radially inward from an end of the second body portion 30 opposite the annular edge 32. The pot bottom wall 38 forms an angle with the second body portion 30, which is referenced herein as angle Op. The second body portion 30 has a diameter proximal the pot bottom wall 38, which is referenced herein as diameter D_{PBW}, and which is discussed with further detail below in connection with the tray 14. The pot bottom wall 38 preferably extends in a parallel plane with respect to the rim bottoms 22a, 22b and the lower surface 22c.

The pot bottom portion 34 further includes a plurality of openings defined by the pot bottom wall 38. In some aspects of the invention, about thirty percent to about one hundred percent (fully open) of the pot bottom portion 34 is a negative space, such as one or more openings defined by the pot bottom portion 34. In some aspects of the invention, about sixty percent to about seventy percent of the pot bottom portion 34 is negative space and, in some aspects of the invention, about sixty-five percent of the pot bottom portion 34 is negative space. Thus, respectively, the ratio of negative space to positive space of the pot bottom portion 34 is, in some aspects of the invention, between about 3:7 and about 1:0, between about 3:2 and about 7:3, and/or about 2:1, e.g., about 13:7 (65% open).

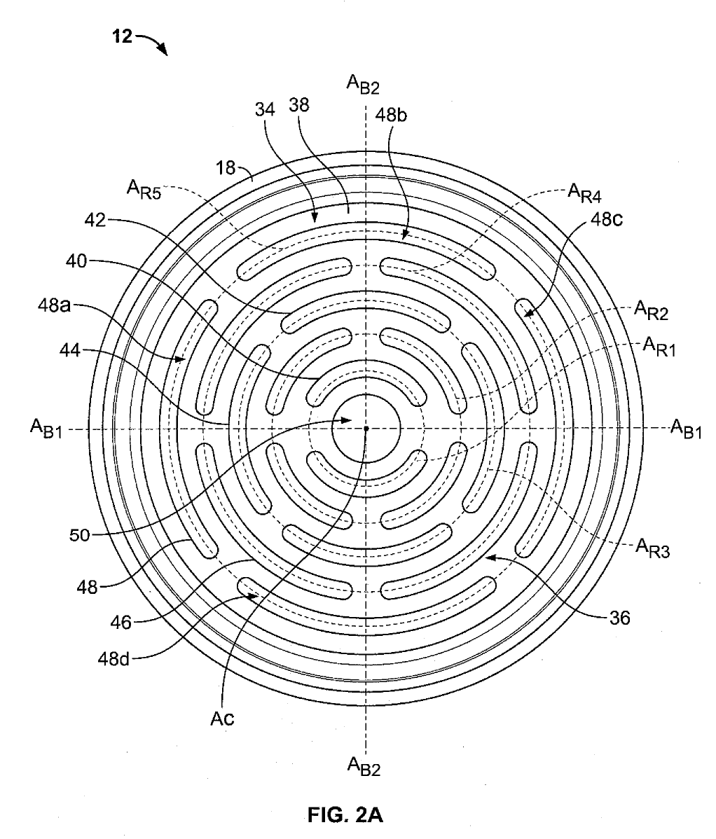

The pot bottom portion 34 is shown to include an example of such negative space. In the example of FIG. 2A, the pot bottom portion 34 includes the pot bottom wall 38 and six groups of openings defined in the pot bottom wall 38 to have a substantially even distribution about the central axis A_{C}. It is contemplated, however, that the pot bottom portion 34 can have any number of one or more openings and any arrangement suitable for facilitating root growth through the openings into the surrounding soil in which the plant pot 12 is buried and/or placed on top of. For example, referring to FIG. 2B, the pot bottom portion 34 can include the pot bottom wall 38 and a matrix or array of openings 39 extending through the pot bottom wall 38, such that the pot bottom portion 34 is substantially open.

Continuing with reference to FIG. 2A, the openings may be aligned along concentric radial axes A_{R1}, A_{R2}, A_{R3}, A_{R4}, A_{R5}. For example, a first group of openings 40 is aligned along the radial axis A_{R1}, a second group of openings 42 is aligned along the radial axis A_{R2}, a third group of openings 44 is aligned along the radial axis A_{R3}, a fourth group of openings 46 is aligned along the radial axis A_{R4}, and a fifth group of openings 48 is aligned along the radial axis A_{R5}. A sixth group 50 includes a single opening defined by the pot bottom wall 38 at an intersection thereof with the central axis A_{C} (e.g., the center point of the pot bottom wall 38). It shall be understood that the radial axes A_{R1}, A_{R2}, A_{R3}, A_{R4}, A_{R5}, can be provided so as to be “substantially radial.” As used herein, a “substantially radial axis” can have any shape substantially extending around the central axis A_{C}, which includes a circle (as shown) and which further includes other shapes, such as a square, a pentagon, a hexagon, an octagon, etc.

Each one of the groups of openings 40, 42, 44, 46, 48, 50 (and axes thereof) could be radially and evenly spaced apart from each other one of the groups of openings 40, 42, 44, 46, 48, 50 (and axes thereof adjacent thereto. Moreover, each member of a group may be angularly and evenly spaced apart from each other member adjacent thereto. As an example of the latter, it is shown that the fifth group of openings 48 includes four openings 48a, 48b, 48c, 48d and that each one of the four openings 48a, 48b, 48c, 48d is angularly spaced apart from each other one of the four openings 48a, 48b, 48c, 48d adjacent thereto. The arrangement of the groups of openings 40, 42, 44, 46, 48, 50 provide a pot bottom portion 34 having a substantially even distribution of negative space defined in the pot bottom wall 38. For example, the pot bottom portion 34 can be symmetrical about a first axis bisecting the pot bottom wall 38, which is referenced herein as a first bisecting axis A_{B1}, and can be further symmetrical about second bisecting axis A_{B2} perpendicular to the first bisecting axis A_{B1}. In this regard, each quadrant (not designated) of the pot bottom portion 34 has substantially the same amount and orientation of positive and negative space. When the plant pot 12 has been planted above and/or within surrounding soil and with a plant and pot soil contained in the plant chamber 36, the groups of openings 40, 42, 44, 46, 48, 50 allow for root growth therethrough into the surrounding soil from the soil in the plant chamber 36. The openings, such as the openings 48a, 48b, 48c, 48d, can have the shape of an annular sector. Such a shape presents advantages in that it provides an enhanced amount of contiguous negative space, thereby allowing a root to extend therethrough at very small angles relative to the pot bottom wall 38.

The groups of openings 40, 42, 44, 46, 48, 50 can be staggered, such that the positive space of the pot bottom wall 38 is staggered to provide a substantially constant amount of structural integrity throughout portions thereof. For example, when the plant pot 12 is carried without the tray 14, the downward force of the plant and pot soil contained in the plant chamber 36 are preferably supported evenly throughout the bottom wall 38. In this regard, the pot bottom portion 34 provides an arrangement of positive space (bottom wall 38) and negative space (the openings 40, 42, 44, 46, 48, 50) to both facilitate root growth and provide structural integrity, which is particularly advantageous for a plant pot 12 containing weighty plants and/or pot soil. As indicated above, however, it is contemplated that the pot bottom portion 34 can be fully-open so as to have, for example, no pot bottom wall 38.

Referring to FIGS. 1 and 4-6, a sample bottom cover, such as the tray 14 shown therein, shall now be discussed with further detail for the purpose of example. The tray 14 includes an annular bonnet 52 that has a C-shaped cross-section and further includes an annular flange 54 extending from the annular bonnet 52. When the tray 14 receives the plant pot 12, the annular bonnet 52 and the N annular flange 54 extend about the central axis A_{C}.

Continuing with reference to FIGS, 1 and 4-6 and with further discussion of a sample cover, the tray 14 includes a sidewall 56 extending from the annular flange 54 and a tray bottom portion 58, which includes a tray bottom wall 60 that extends radially inward from a side of the sidewall 56 opposite the annular flange 54. The sidewall 56 tapers (gets smaller) upwardly and in a direction toward the annular flange 54, such that a cross-section of the sidewall 56 proximal the annular flange 54 has a radius less than a radius taken at a cross-section of the sidewall 56 proximal the tray bottom wall 60. A second annular edge 62 could be formed at the juncture of the sidewall 56 and the annular flange 54. A chamber, referenced herein as a receiving area 64, is defined between the sidewall 56 and the tray bottom wall 58 for securing receiving the plant pot. The sidewall 56 has a diameter proximal the tray bottom wall 60, which is referenced herein as diameter D_{TSW}, and which is just greater than the diameter D_{PBW} of the pot bottom wall 38.

The tray bottom portion 58 may include a plurality of drain holes 66a-e defined by and through the tray bottom wall 60 for fluid communication with the plant chamber 36 via one or more of the openings of the groups thereof 40, 42, 44, 46, 48, 50. When the plant pot 12 is seated within the receiving area 64, the drain holes 66a-e can be aligned along the first and second bisecting axes A_{B1}, A_{B2}. To facilitate drainage of water from the plant pot 12, when the plant pot 12 is seated within the receiving area 64, the drain holes 66a-e could be aligned with one or more of the openings formed in the pot bottom wall 38, such as the four openings 48a, 48b, 48c, 48d and the single opening of the sixth opening group 50. Alternatively where there is a space between the tray and the pot bottom wall, openings in the tray and the pot bottom wall may be unaligned.

Referring to FIGS. 1 and 4-6A, the plant pot 12 and the tray 14 form a snap-fit for securingly seating the plant pot 12 within the receiving area 64 of the tray 14 (though it is contemplated that a cover, such as the tray 14, can be secured to the plant pot 12 by any suitable means known in the art). The tray 14, and, more particularly, the sidewall 56, is formed of a resiliently flexible material, such as plastic and at least one slit 15, but preferably a plurality of slits 15, is formed in the sidewall 56 (and the annular bonnet 52 and the annular flange 54) to permit and/or facilitate expansion. When the tray 14 and the plant pot 12 are provided in an unassembled state, the tray 14 is in a first position, where the tray bottom wall 60 forms a first angle with the sidewall 56, which could be less than the angle θ_{P} of the plant pot 12. Though a tray 14 and a snap-fit therefor are discussed herein, such discussion shall be understood as exemplary, and accordingly, it shall be further understood that any suitable cover can be provided for enclosing the bottom of the plant pot 12, and that any suitable means known in the art can be utilized for securing the cover to the plant pot 12.

Continuing with discussion of a sample bottom cover, such as the tray 14, when the tray 14 and plant pot 12 are in an assembled state, the second body portion 30 of the plant pot 12 is positioned within the receiving area 64, such that the pot bottom wall 38 is seated adjacent the tray bottom wall 60, which flexes the sidewall 56 into a second position, where a second angle is formed between the sidewall 56 and the tray bottom wall 60 that is just greater than the angle θ_{P} of the plant pot 12. Though the sidewall 56 is generally resilient, the slits 15 can be formed therein to facilitate flexing. At least in part due to the diameter D_{PBW} of the pot bottom wall 38 being just less than the diameter D_{TSW} of the sidewall 56, the inward bias provided by the resilience of the sidewall 56 contacts the second body portion 30. The second annular edge 62 of the tray 14 “snaps” to the first annular edge 32 of the plant pot 12, such that the tray 14 is secured to the bottleneck formed in the body 24 of the plant pot 12 at the juncture of the first body portion 28 and the second body portion 30. Naturally, when in an unassembled state, e.g., the first position, the tray 14 is configured such that the sidewall 56 is resiliently flexible into such second position to provide the structure, function, etc. of the second position.

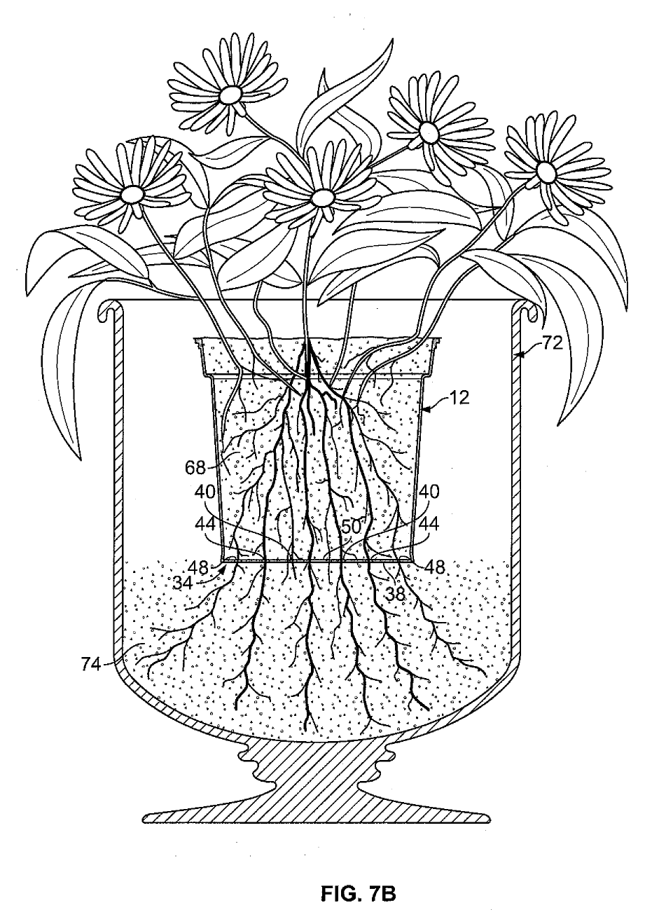

Referring to FIG. 7A, an exemplary method of the present invention shall now be described with further detail. A system is provided that includes a plant pot and a tray, such as the plant pot 12 and the tray 14 described above. A plant and pot soil 68 are put inside the plant chamber 36 of the plant pot 12, and, as the plant pot 12 is carried without the tray 14, structural support is provided by the staggered positive space of the pot bottom wall 38, while the pot bottom portion 34 preferably has about sixty-five percent negative space, for example. As indicated above, however, staggered positive and negative space is not required, as the pot bottom portion 34 can be provided to have substantially one hundred percent (100%) negative space, and, in some aspects, no bottom wall 38.

A user assembles the plant pot 12 with the bottom cover, such as the tray 14, in any number of ways, including the following, for example. The user inserts the second body portion 30 of the plant pot 12 into the receiving area 64 of the tray 14, thereby flexing the sidewall 56 of the tray 14 until the pot bottom wall 38 is adjacent the tray bottom wall 60 and the sidewall 56 snaps into the second position, where the sidewall 56 is biased against the second body portion 30 and where the second annular edge 62 surrounds the first annular edge 32. The user can rotate at least one of the plant pot 12 and the tray 14 relative to the other one so as to align one or more of the drain holes 66a-e with one or more openings of the groups 40, 42, 44, 46, 48, 50 thereof so as to facilitate drainage of water from the plant pot 12 through the drain holes 66a-e. Such rotation can occur after or during insertion of the plant pot 12 into the receiving area 64.

When the user is desirous of planting, the user pulls at least one of the plant pot 12 and the tray 14 away from the other, thereby flexing the sidewall 56 to separate the first and second annular edges 32, 62. The user can dig a hole into the ground soil 70, and place the plant pot 12 into the hole, or place the pot on top of soil. The groups of openings 40, 42, 44, 46, 48, 50 facilitate root growth from pot soil 68, through the openings 40, 42, 44, 46, 48, 50, and into ground soil 70.

Referring to FIG. 7B, it shall be understood that the methods described herein do not require that the plant pot be “buried in the ground” per se. For example, as shown in FIG. 7B, the plant pot 12 can be used in combination with a decorative planting structure 72. When the user is desirous of planting, the user pulls at least one of the plant pot 12 and the tray 14 away from the other. The user can places the plant pot 12 on top of soil 74 that is contained within the decorative planting structure 72 The openings 40, 42, 44, 46, 48, 50 facilitate root growth from the pot soil 68, through the openings 40, 42, 44, 46, 48, 50, and into the soil 74 contained by the decorative planting structure 72.

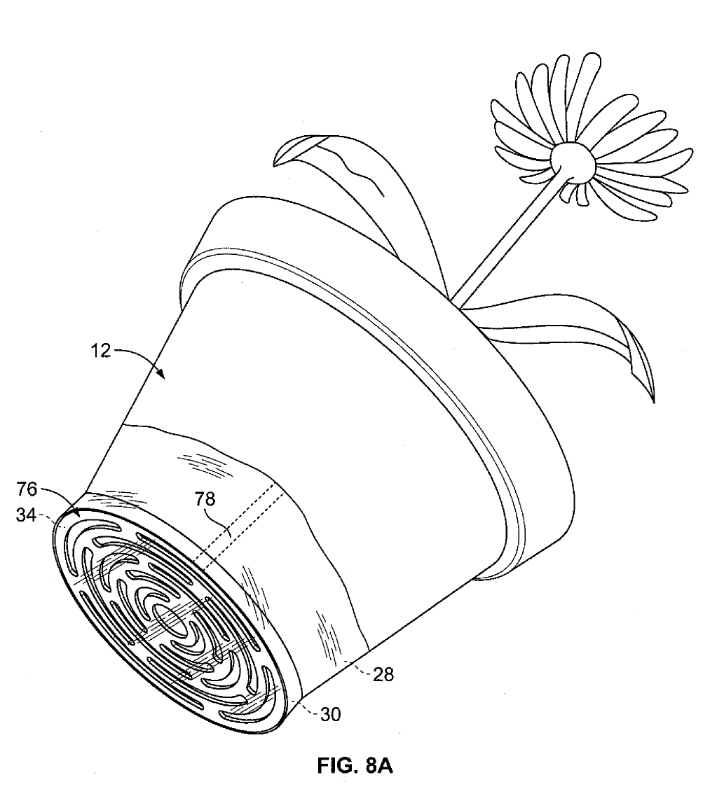

Referring to FIG. 8A, it is also shown that the bottom cover can be provided in the form of wrapping 76 for enclosing the bottom portion 34 of the plant pot 12, thereby retaining any soil 68 and plant within the pot 12 during shipping and display. The wrapping 76 can be provided as shrink wrap, transparent or otherwise. It is contemplated that the wrapping 76, e.g., shrink-wrap, can include a perforation 78 to facilitate removal of the wrapping 76 from the bottom wall 38 and the negative E space extending therethrough. It is further contemplated that the plant pot 12 can be formed of a fibrous material. As shown in FIG. 8B, the wrap can both enclose the bottom portion 34 and extend up to, and even over, the entire pot.

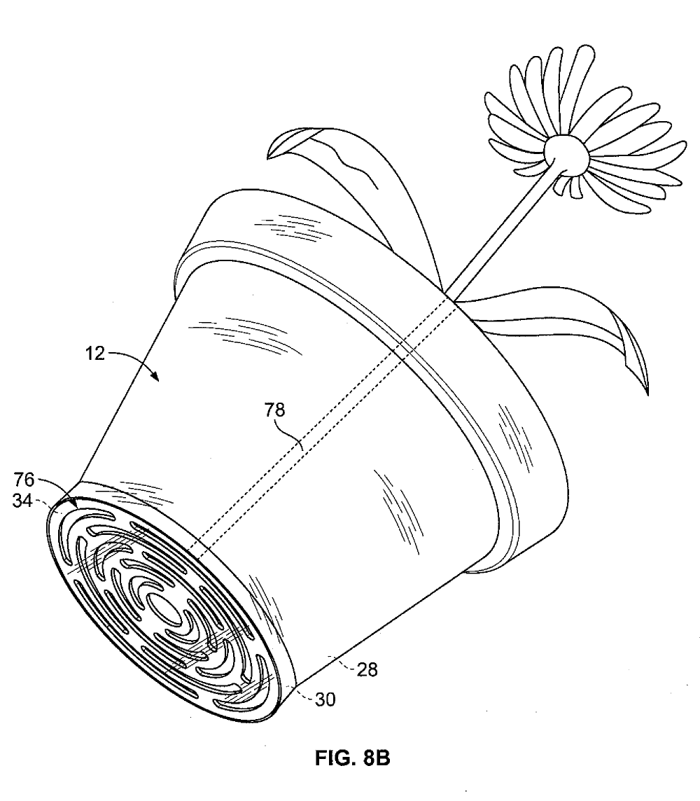

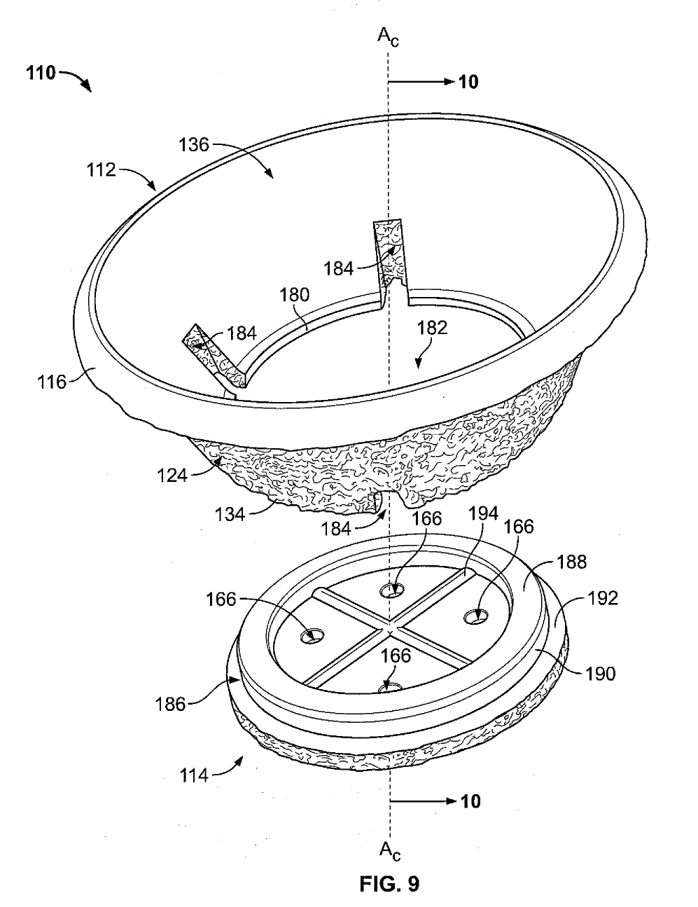

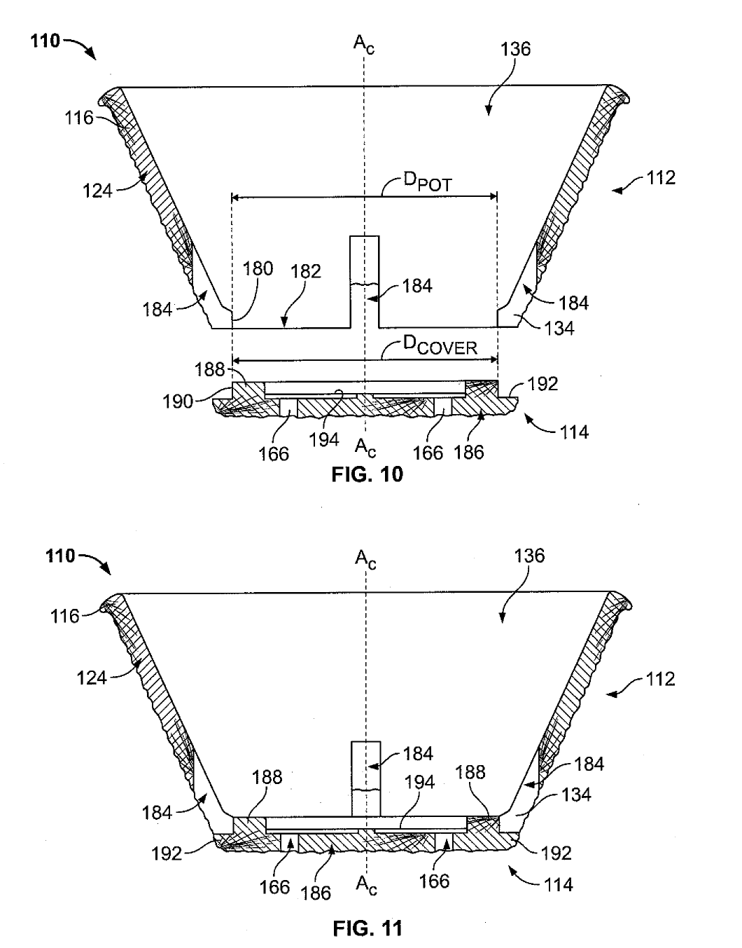

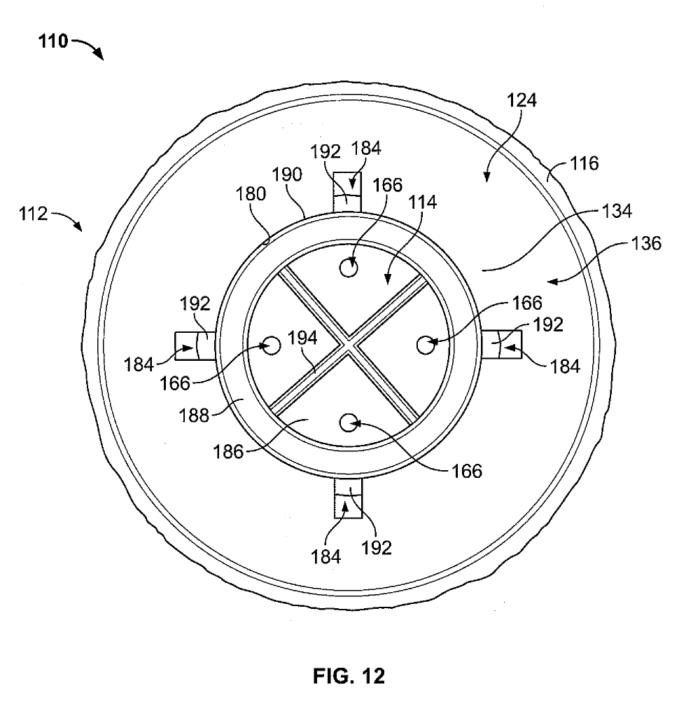

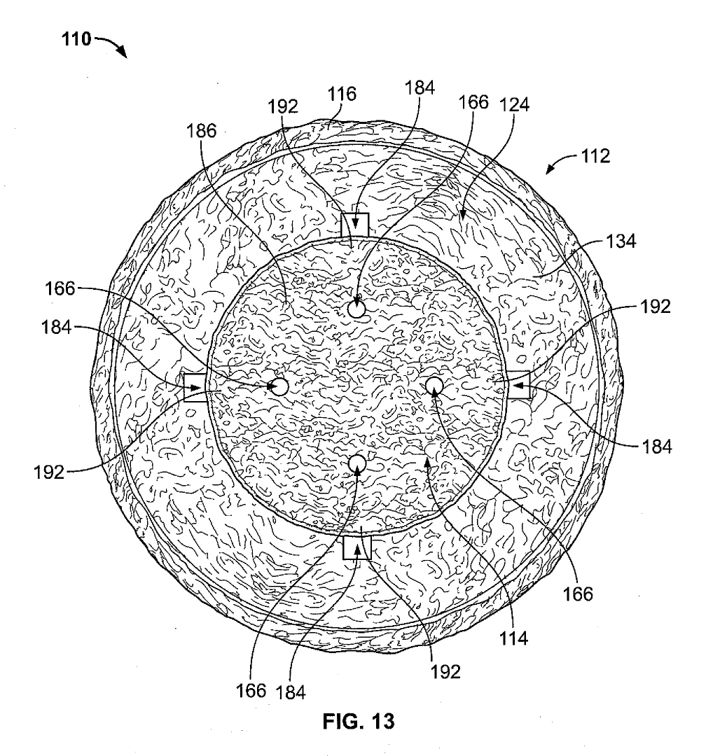

Referring to FIGS. 9-13, an example is shown of a plant pot 112 provided with a substantially open pot bottom portion 134 that is fully-open, e.g., approximately one hundred percent (100%) open. Plant pot and cover systems of the present invention can be formed of any suitable material known in the art, and, for the purpose of example, the plant pot and cover system 110 of FIGS. 9-13 is shown to include a plant pot 112 and a cover 114 therefor that are both formed of a fibrous material, such as, for example, paper fiber, recycled paper fiber, or other biodegradable material. The plant pot 112 can be manufactured by setting the fibrous material about a mold, thereby providing smooth interior surfaces. One benefit of using fibrous material, or other biodegradable material, is that after the pot is placed on or in soil, it will break down over time and disappear over time. As such, a plant pot according to the present invention is environmentally friendly, i.e., “Green.”

Continuing with reference to FIGS. 9-13, the plant pot 112 can include a top portion 116, which may be formed as a rim, and the top portion 116 can extend annularly about the central axis A_{C}. The plant pot 112 can include a body 124 that extends from the top portion 116 and about the central axis A_{C} to define a chamber, referenced as a plant chamber 136. The body 124 is formed of a continuous sidewall extending from the top portion 116 so as to be tapered (getting smaller) in a direction away from the top portion 116. The body 124 includes a pot bottom portion 134 that has an inner edge 180, which is shown to be extending annularly about the central axis A_{C} to define an opening 182 having a diameter D_{POT}. The body 124 includes a plurality of open channels, which serve as finger apertures 184, and which extend from the inner edge 180 in a direction toward the top portion 116. The finger apertures 184 can be evenly spaced about the circumference of the pot bottom portion 134, though such is not required.

Continuing with reference to FIGS. 9-13, the cover 114 includes a circular base 186 and an annular boss 188 extending therefrom in a direction toward the top portion 116 of the plant pot 112. The annular boss 188 has an outer edge 190 having a diameter D_{COVER} that is the same or slightly greater than the diameter D_{POT} of the opening 182 defined by the inner edge 180 of the plant pot 112, such that the outer edge 190 of the annular boss 188 of the cover 114 forms a friction fit with the inner edge 180 of the bottom portion 134 of the plant pot 112 when the cover 114 is inserted in the opening 182 of the bottom portion 134 of the plant pot 112. The circular base 186 has a diameter greater than that of the annular boss 188, so as to form an annular flanged area 192 proximal at least one of the finger portals 184. The cover 114 can define a plurality of drain holes 166 as desired, and ribs 194 can be provided on the circular base 186 or as otherwise desired.

In use, assembly of the system 110 can be achieved by urging the annular boss 188 through the opening 182 of the plant pot 112, until the outer edge 190 of the annular boss 188 forms a friction fit with the inner edge 180 of the pot bottom portion 134 of the plant pot 112. Soil and plants can be placed within the plant chamber 136 of plant pot 112, and the pots with plants can be transported and displayed for sale. A purchaser can transport the pot and plant to a location where the user intends to plant the pot 112 on or in the soil of the ground 70 (see FIG. 7A) or on or in a decorative planting structure 72 (see FIG. 7B), for example. The user can insert his or her finger(s) through the finger portals 184, and urge the annular flanged area 192 of the circular base 186 in a direction away from the top portion 116 of the plant pot 112, thereby releasing the friction-fit formed by the annular boss 188 and the pot bottom portion 134. Then, the plant pot 112 can be placed in and/or on top of the soil of the ground 70, or in and/or on top of the soil of the decorative planting structure 72. After time, the fibrous pot will degrade and disappear.

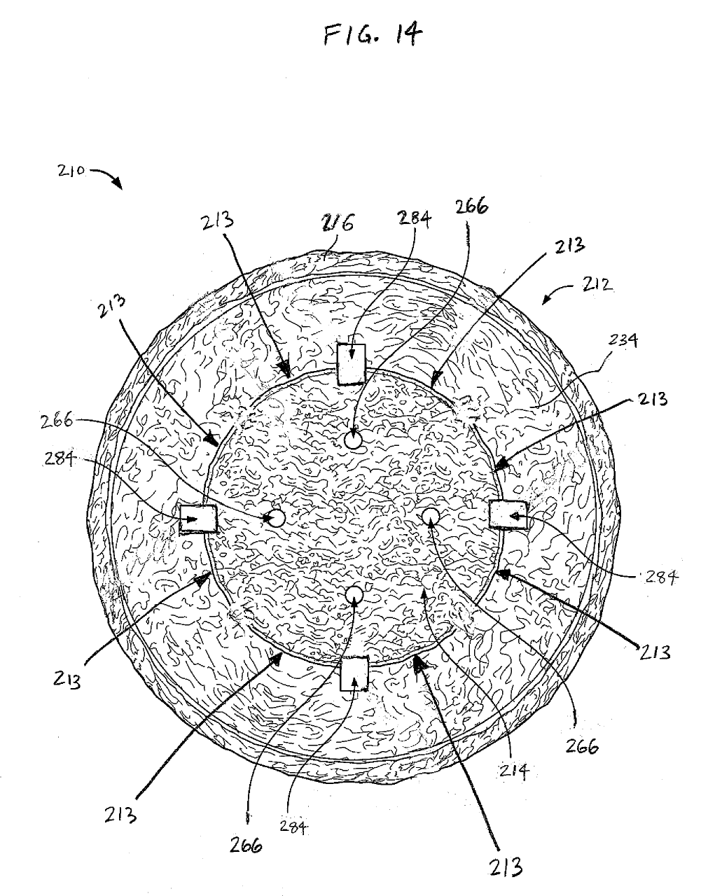

Referring to FIG. 14, wherein like reference numerals refer to like components, the plant pot and cover system 210 can alternatively be integrally formed, such as where the plant pot 212 and the pot bottom (cover) 214 are unitarily formed as one piece, for example. In such circumstances, the plant pot 212 could include the finger portals 284, and perforations 213 could be formed by die cutting or punching, for example, along an outer edge of the pot bottom 214, or another location, so that the pot bottom 214 attaches to the pot bottom portion 234 only at discrete locations. In this regard, when the pot bottom 214 is to be released, a user can insert his or her finger(s) through the finger aperture(s) 284 and urge the pot bottom 214 in a direction away from the top portion 216 of the plant pot 212, thereby breaching the perforation and detaching the cover 214 from the plant pot 212. Then, the plant pot 212 can be placed in and/or on top of the soil of the ground, or in and/or on top of the soil of a decorative planting structure. It is noted that the pot bottom 214 could optionally include drainage holes 266.

It should be understood that the various embodiments of the present invention could be made of any suitable material and those embodiments disclosed as being made of a fibrous material could be made of any other material, such as plastic, and vice versa.

It shall be understood that the embodiments of the present invention described herein are merely exemplary and that a person skilled in the art may make many variations and modifications without departing from the spirit and scope of the invention. All variations and modifications, including those discussed above, are intended to be included within the scope of the invention as defined in the appended claims.

1. A plant pot and cover system, comprising:
a plant pot including a body and further including a pot bottom portion extending from said body and defining therebetween a plant chamber configured to, in use, contain a plant and soil, said pot bottom portion including negative space formed of at least one opening defined through said pot bottom portion to said plant chamber so as to allow root growth from said plant chamber through said negative space; and
a cover configured to, when in use with said plant pot, releasably attach to said plant pot and substantially enclose said negative space opposite said plant chamber.

2. The system of claim 1, wherein said pot bottom portion includes a positive space formed of a pot bottom wall that has said negative space defined therethrough.

3. The system of claim 2, wherein said at least one opening comprises a plurality of openings.

4. The system of claim 3, wherein said positive space and said negative space are substantially evenly distributed across said pot bottom portion.

5. The system of claim 3, wherein said plurality of openings includes a first group of openings defined through said pot bottom wall in alignment with a first substantially radial axis extending about a central axis through said pot bottom wall.

6. The system of claim 5, wherein said plurality of openings further include a second group of openings defined through said pot bottom wall in alignment with a second substantially radial axis spaced apart from said first substantially radial axis.

7. The system of claim 1, wherein said cover includes a tray.

8. The system of claim 7, wherein said tray includes a tray bottom wall defining a drain hole configured to, when in use with said plant pot, be aligned with at least a portion of said negative space for fluid communication therewith.

9. The system of claim 7, wherein said tray includes a tray bottom wall and a sidewall defining with said tray bottom wall a receiving area therebetween sized and shaped to, when in use with said plant pot, releasably attach to said plant pot.

10. The system of claim 1, wherein said cover includes wrapping configured to, when in use with said plant pot, substantially enclose said negative space opposite said plant chamber.

11. The system of claim 10, wherein said wrapping is shrink-wrap.

12. The system of claim 10, wherein said wrapping includes a perforation.

13. The system of claim 1, wherein said at least one opening defined through said pot bottom portion comprises substantially the pot bottom portion.

14. The system of claim 1, wherein said cover is configured to form a friction fit with said plant pot so as to substantially enclose said negative space.

15. (canceled)

16. (canceled)

17. A plant pot and cover system, comprising:
a plant pot including a body and further including a pot bottom portion extending from said body and defining therebetween a plant chamber configured to, in use, contain a plant and soil, said pot bottom portion including positive space formed of a pot bottom wall and further including negative space formed of a plurality of openings defined through said pot bottom wall to said plant chamber, a ratio of said negative space to said positive space being between about 3:2 and about 7:3, so as to allow root growth from said plant chamber through said negative space; and
a cover configured to, when in use with said plant pot, securingly receive said plant pot and substantially enclose said negative space opposite said plant chamber.

18. The system of claim 17, wherein said positive space and said negative space are substantially evenly distributed across said pot bottom portion.

19. The system of claim 17, wherein said plurality of openings includes a first group of openings defined through said pot bottom wall in alignment with a first substantially radial axis extending about a central axis through said pot bottom wall.

20. The system of claim 17, wherein said plurality of openings further includes a second group of openings defined through said pot bottom wall in alignment with a second substantially radial axis spaced apart from said first substantially radial axis.

21. The system of claim 17, wherein said cover includes a tray, and wherein said tray includes a tray bottom wall and a sidewall defining with said tray bottom wall a receiving area therebetween sized and shaped to, when in use with said plant pot, releasably receive said plant pot.

22. A planting system, comprising:
a plant pot including a body having a first body portion and a second body portion extending therefrom, and further including a pot bottom portion extending from said second body portion and defining with said body a plant chamber configured to, in use, contain a plant and soil, said pot bottom portion including positive space formed of a pot bottom wall and further including negative space formed of a plurality of openings defined through said pot bottom wall to said plant chamber, said plant pot configured to, when positioned adjacent soil external of said plant chamber, allow root growth from said plant chamber through said negative space into the soil external of said plant chamber; and
a tray including a tray bottom wall configured to, when in use with said plant pot, substantially enclose said negative space opposite said plant chamber, and further including a sidewall defining with said tray bottom wall a receiving area configured to, when in use with said plant pot, seat said body, said sidewall being configured to, when in use with said plant pot, securingly engage said body to inhibit inadvertent removal of said plant pot from said tray.

23. The system of claim 22, wherein said sidewall of said tray is resiliently flexible to provide a biasing force which, when said body is within said receiving area, secures at least a portion of said body therein.

24. The system of claim 22, wherein said sidewall forms a snap-fit with said body.

25. The system of claim 22, wherein said sidewall includes at least one slit.

26. The system of claim 22, wherein said first body portion and said second body portion form at a juncture thereof an annular edge, wherein said second body portion tapers toward said annular edge, and wherein said sidewall tapers away from said tray bottom wall to, when in use with said plant pot, secure said second body portion within said receiving area.

27. A method of planting potted plants, comprising:
providing a plant in a plant pot having a pot bottom portion with negative space formed of a one or more openings defined through the pot bottom wall and a tray attached to the plant pot and covering the one or more openings in the pot bottom wall;
removing the tray from the plant pot;
positioning the plant pot on soil such that the one or more openings are adjacent to the soil; and
allowing plant roots to grow from the plant pot, through the one or more openings and into the soil.

28. The method of claim 27, further comprising placing a plant and pot soil into the plant pot.

29. The method of claim 28, further comprising, prior to removal of the tray, securingly engaging the plant pot within a receiving area of the tray to substantially enclose the negative space of the pot bottom wall.

30. A method for shipping potted plants, comprising:
providing a plant pot defining a plant chamber and having a pot bottom portion with positive space formed of a pot bottom wall and negative space formed of one or more openings defined through the pot bottom wall to the plant chamber;
providing soil in the plant chamber;
providing a plant with roots thereof in the soil; and
securingly engaging the plant pot within a receiving area of a tray to substantially enclose the negative space opposite the plant chamber.

31. The method of claim 30, further comprising, after shipping the potted plants, placing the potted plants by removing the tray from the plant pot and positioning the plant pot on soil external of the plant chamber such that the openings are adjacent to the soil external of the plant chamber.

32. A method of planting a potted plant, comprising:
providing (i) a plant pot defining an open bottom and a plant chamber, and (ii) a cover in secured arrangement with the plant pot and enclosing the opening;
removing the cover from the plant pot; and
positioning the plant pot such that the open bottom is adjacent to soil.

33. A plant pot comprising:
a frustoconical side wall; and
a bottom wall removably attached to the sidewall, wherein when the bottom wall is removed, the plant pot has substantially an open bottom.

34. The plant pot of claim 33, wherein the bottom wall frictionally engages the side wall.

35-38. (canceled)
